(19) United States
(12) Patent Application Publication
(10) Pub. No.: US 2009/0121636 A1
(43) Pub. Date: May 14, 2009

(54) High-Pressure Discharge Lamp

(75) Inventors: Volker Dirk Hildenbrand, Eindhoven (NL); Marco Haverlag, Eindhoven (NL); Antonius Cornelis Van Amstel, Eindhoven (NL); Bennie Simpelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,630

(22) PCT Filed: Apr. 3, 2006
(86) PCT No.: PCT/IB2006/050997

§ 371 Date: Oct. 4, 2007

(30) Foreign Application Priority Data
Apr. 8, 2005 (EP) 05102772.0
Nov. 3, 2005 (EP) 05110285.3

(51) Int. Cl. H01J 61/30

(52) U.S. Cl. 313/634

(57) ABSTRACT

The invention relates to a high-pressure discharge lamp intended for use in assimilation lighting. According to the invention, the high-pressure discharge lamp has a discharge vessel with a long axis, enclosing a volume V wherein an ionizable filling comprising a buffer gas and an excess amount of a metal halide, which is selected from LiI, NaI and CaI₂, is present, the discharge vessel having an inflated shape wherein at least the ends are non-cylindrical and curved towards the long axis at both ends, with an inner wall area A for which it holds that A/V<6.6.

The invention relates to a high-pressure discharge lamp, which is in particular suited for use in plant growing irradiation and assimilation lighting in greenhouses.

The light absorption by green leaves is strongest in the blue and the red part of the spectrum. Photons (quanta) between 400 and 700 nm determine the rate of photosynthesis. As absorption of these photons is the driving force for photosynthesis. A spectral quantum yield of photosynthesis has been derived by McCree (The action spectrum, absorptance and quantum yield of photosynthesis in crop plants, Agric. Meteorol. 1971/1972, 9. 191-216) and refined by Sager et al. (Light Energy Utilization Efficiency for Photosynthesis, Transactions of the ASAE, General Edition, 1982, 25/6, 1737-1746). These studies teach that the yield of photosynthesis is high over a wide region having relative maxima in the blue and the red part of the spectrum. Despite the above-mentioned two maxima in the blue and the red part the quantum yield is >0.8 in the region between 400 and 700 nm. High-intensity discharge lamps with Na or NaI efficiently emit radiation in particular in the region of the NaD-line at 589 nm, where the absorption of the chlorophyll is strong. Particularly, high-pressure sodium (called SON or alternatively HPS) lamps are therefore used at present for assimilation lighting in greenhouses. SON lamps attain luminous efficacies of between 100 and 150 lm/W and photon flux efficiencies of up to 1.95 μmole/(Ws).

High-intensity discharge lamps with NaI and CeI₃ fillings have comparable luminous efficacies. EP 0 896 733 discloses a metal-halide system with NaI and CeI₃, which can achieve efficacies between 130 and 174 lm/W. The luminous efficacy decreases when Li is added. U.S. Pat. No. 6,147,453 discloses a lamp with NaI, CeI₃, and an LiI filling, which achieves luminous efficacies of no more than 100 to 135 lm/W. WO 00/45419 discloses low-wattage lamps with a filling comprising NaI, CaI₂ and CeI₃ in addition to Hg. These lamps have a luminous efficacy between 101 and 106 μm/W with a high color temperature T_{c} above 3800K, up to above 4800K, in combination with a general color rendering index Ra in the range of 84 to 90.

For an efficient support of plant growth, lamps must generate light very efficiently in the region where the photosynthetic yield is a maximum. A main drawback with respect to comparing the above-mentioned lamps is that the photoactive spectrum of plants significantly deviates from the eye-sensitivity curve used for the calculation of luminous efficacies. Whereas the eye sensitivity curve peaks in the green and the eye sensitivity in the blue and red region is small, the sensitivity curve for radiation active in photosynthesis has maxima in the blue and the red part. The luminous efficacy is therefore not a good parameter in assessing the amount of radiation active in photosynthesis. It is more appropriate to use the photon flux between 400 and 700 nm divided by the lamp input power, further called the photon flux efficiency for optimizing lamps useful for assimilation or growth lighting. It is even possible that an increased luminous efficiency results in a negative effect on the photon flux efficiency.

The main drawback of the known lamp with the filling comprising the combination of NaI, CaI₂, CeI₃, and LiI is that it emits a considerable amount of light in the green region of the spectrum, where the photosynthetic yield is lowest. Although it has a high luminous efficacy, it is less suitable for stimulation of plant growth than lamps on the basis of Na or NaI, which emit more efficiently in the red part of the spectrum. Both the lamp with a filling comprising NaI/CeI₃ and the one comprising Na, Ce and Li halides have the drawback of being susceptible to demixing phenomena of the filling during lamp operation.

The main disadvantage of SON lamps and lamps having only NaI as the halide filling is that they emit mainly around 589 nm, although the plants still absorb photons very efficiently up to approximately 700 nm. Furthermore, a SON lamp has an insignificant contribution in the blue part of the spectrum. The conversion of electrical power into photons of said lamps is therefore not ideal in relation to the plant absorption spectrum.

In the literature, a lamp for promoting plant growth is proposed having a ceramic discharge vessel containing Hg, LiI in an amount of between 0.02 to 4.2 mg/cm³, and an excess of Li to compensate for effects of corrosion. The spectrum of the lamp has a relatively large quantity of the emitted light in the green part of the spectrum, which is generated by the Hg in the discharge. This is a drawback as it is not really effective in plant growth.

The invention has for its object to provide a lamp suited for use in plant growth irradiation and assimilation lighting in greenhouses in which the above drawbacks are counteracted.

According to the invention, the high-pressure discharge lamp has a discharge vessel with a long axis enclosing a volume V, wherein an ionizable filling is present comprising a buffer gas and an excess amount of substantially LiI as a metal halide, the discharge vessel having an inflated shape that curves towards the long axis at both ends, with an inner wall area A for which it holds that A/V<0.66 mm⁻¹, which discharge vessel has a coldest-spot temperature T_{cs} of at least 1200 K during normal operation. Normal operation of the lamp is understood in this respect to be stable operation at a lowest power and on a corresponding voltage for which the lamp has been designed. Hg is frequently used as a buffer gas. Besides, the discharge vessel may comprise a rare gas like Ar, Kr or Xe, or a mixture of thereof, which promotes starting and can also have a buffer gas capacity. In particular Xe also has a buffer gas capacity with increased fill pressures. The discharge vessel may be made of ceramic or quartz or quartz glass material. ‘Ceramic material’ here denotes a translucent or transparent monocrystalline or densely sintered polycrystalline metal oxide, like Al₂O₃, Y₂O₃, Y₃Al₅O₁₂ (YAG) and densely sintered metal nitride, like AlN. The discharge vessel is non-cylindrical at least at its ends as a consequence of the inflated shape being curved towards the long axis at both ends. This is advantageous for controlling the cold-spot temperature. A 150 W LiI-filled lamp according to the invention with mercury as a buffer gas and a ceramic alumina discharge vessel, for example, emits 15 to 20% of its radiation in the blue region between 400 and 500 nm and about 75% in the red region between 600 and 700 nm, which are surprisingly high percentages. The emission of the lamp thus matches the absorption spectrum of green plants surprisingly very well, which match is much better than that of a high-pressure sodium lamp, where only up to 10% is emitted in the blue region and at most about 40% in the red region. The high percentage of blue light in the spectrum of the invented lamp was in itself unexpected because the main lines of Li are at 611 and 671 nm. A further surprising advantage of the lamp according to the invention is that no traces of serious corrosion are recorded. A further advantageous aspect of the lamp is that the Li halide provides a so-called W-halide cycle. Tungsten, which is the most commonly used electrode material, tends to evaporate and/or sputter from the electrode under the influence of the discharge arc. The W-halide cycle has the property of depositing the W thus evaporated and sputtered on a cooler section of the electrode as a result of cyclic bonding to and dissociation from halide evolving from dissociation of the LiI in the discharge area. The principle of the W-halide cycle, which is known per se, promotes the maintenance of the lamp as it effectively counteracts deposition of W on the wall of the discharge vessel.

A major advantage of the inflated non-cylindrical shape is that the wall thickness of the discharge vessel can be kept fairly constant, which is advantageous for realizing an even distribution of the temperature over the wall of the discharge vessel. This is furthermore promoted by the fact that in a body thus shaped, in which A/V<0.66 mm⁻¹, the volume section between an electrode and the associated projecting plug is relatively small in comparison with a cylindrical discharge vessel.

For lamps having a coldest spot T_{cs} below 1200K during operation, it is found that the LiI vapor pressure is not up to the level required for the relatively strong radiation, in particular in the blue region. With Hg as a buffer gas the spectrum then has a very significant contribution in the green part. However, this is ineffective for plant growth.

Whereas the use of LiI as a filling component generally means a reduction of the luminous efficacy (see above), it is surprisingly found that the energy conversion of a lamp according to the invention is at least comparable to or even better than that of a comparable known lamp. For a 150 W lamp with a filling comprising Na or NaI the energy conversion efficiency is about 27%, which value increases to almost 30% for the invented 150 W lamp described above. This increase is surprising and unexpected. Despite the higher blue fraction of the Li spectrum, the photon flux per input power (in μmole/(W*s)) of the invented lamp is found to be even 10% higher than is the case with the comparable lamp having a filling of Na or NaI.

In an advantageous embodiment of the lamp according to the invention, the ionizable filling comprises besides LiI also CeI₃ in a quantity of at most about 10 mole %. The Ce iodide, when in a small quantity, further improves the effective energy conversion in the spectral region between 400 and 700 nm. With larger quantities, however, the Ce iodide provides an increasing amount of green in the spectrum, and besides the Ce has an negative effect on the lamp maintenance as is stimulates the deposition of tungsten on the wall of the discharge vessel.

The new lamp thus provides a higher energy and higher photon efficiency as well as a spectrum that is better adapted to the plant absorption and photosynthetic quantum yield.

In a lamp according to the invention, the discharge vessel preferably encloses a pair of electrodes with a mutual electrode distance EA of at least about 20 mm. Experiments have shown that the photon flux efficiency with electrode distances above about 20 mm is clearly superior to that of comparable lamps having a cylindrically shaped discharge vessel over its full length.

The above and further aspects of the invention will be explained in more detail below with reference to a drawing, in which:

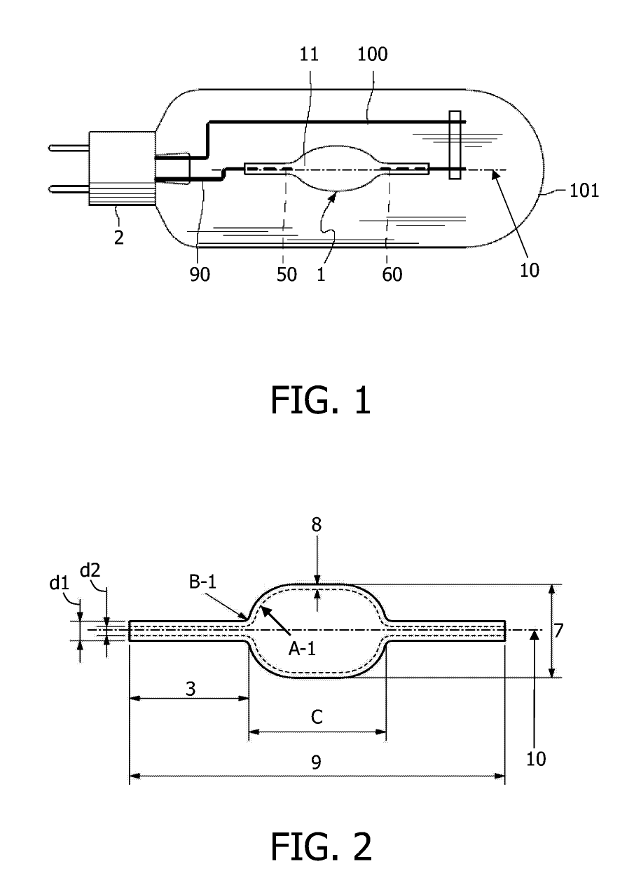

FIG. 1 schematically shows a lamp according to the invention,

FIG. 2 shows the discharge vessel of the lamp of FIG. 1 in detail,

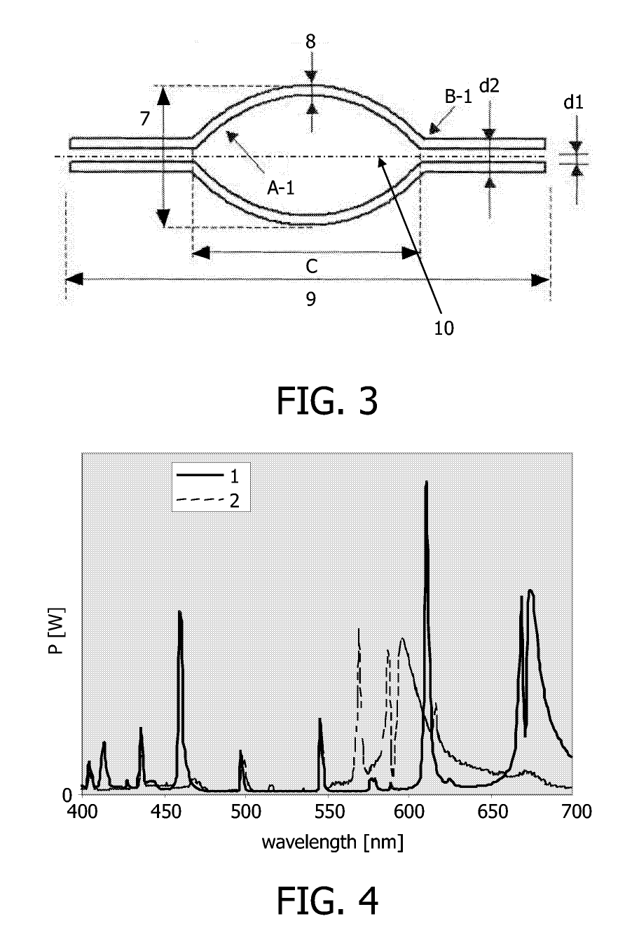

FIG. 3 shows an alternative discharge vessel of the lamp of FIG. 1 in detail,

FIG. 4 shows a spectrum of a lamp according to the invention compared with a non-invented lamp,

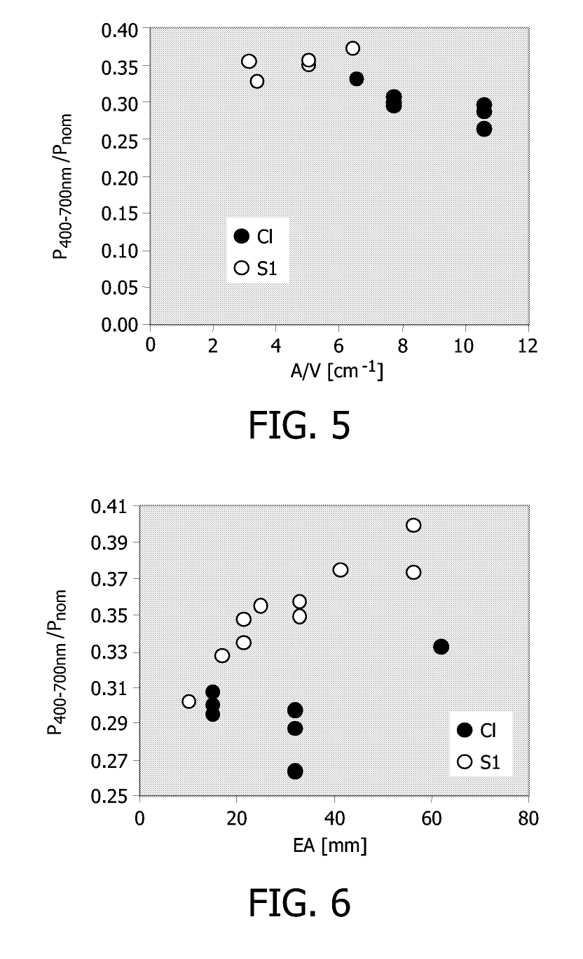

FIG. 5 is a graph showing the ratio of the power between 400 and 700 nm to the input power Pₙₒₘ of the lamps according to the invention as function of the ratio A/V of the discharge vessel, and

FIG. 6 is a graph showing the ratio of the emission power between 400-700 nm to the input power of the lamp as a function of the electrode distance EA.

FIG. 1 shows a discharge lamp according to the invention having a ceramic wall. FIG. 1 shows a metal halide lamp provided with a discharge vessel 1 with a long axis 10 having an inflated shape that curves with a ceramic wall towards the long axis at both ends, which wall encloses a discharge space 11 containing an ionizable filling. The discharge vessel has a non-cylindrical shape over its entire length. Two electrodes 50, 60, whose tips are at a mutual electrode distance EA, are arranged in the discharge space. The discharge vessel has a ceramic projecting plug at either end, each plug enclosing a respective current lead-through conductor. The discharge vessel has a largest internal diameter Di. The discharge vessel is surrounded by an outer bulb 101 which is provided with a lamp cap 2 at one end. A discharge will extend between the electrodes 50, 60 when the lamp is operating. The electrode 50 is connected to a first electrical contact forming part of the lamp cap 2 via a current conductor 90. The electrode 60 is connected to a second electrical contact forming part of the lamp cap 2 via a current conductor 100. The discharge vessel is shown in more detail in FIG. 2 (not true to scale). In this specific embodiment, the inflated shape is formed by non-cylindrical ends curved as two hemispheres towards the long axis 10 and interconnected by a cylindrical part with an outer diameter 7. The discharge vessel has a ceramic wall enclosing a volume V forming the discharge space 11, with an inner wall area A. Each end of the discharge vessel, connected to a respective one of the projecting plugs, is characterized by curvatures with radii A-1 and B-1. In the embodiment shown, the radii are of constant value and the curvatures are sections of circles. Depending on the ratio between the discharge vessel body length C and the radius A-1, the shape of the discharge vessel can thus vary between a sphere on the one hand and two hemispheres connected by a cylindrical part with an outer diameter 7 on the other. In this specific embodiment, twice the radius A-1 equals the outer diameter 7, and d1 and d2 indicate the outer and inner diameter, respectively, of the projecting plugs in which the electrodes are enclosed and sealed, for example, with a ceramic glazing compound.

In a different embodiment, the radius A-1 may be greater than half the outer diameter 7, which results in a more ellipsoidal shape as shown in FIG. 3.

By varying the value of the radius A-1 along the curvature, any desired inflated shape may be realized such as, for example, ellipsoidal, paraboloidal and ovoid. A main advantage of these inflated designs with at least non-cylindrical ends curved towards the long axis is that the wall thickness of the discharge vessel can be kept fairly constant, which is advantageous for realizing an even distribution of the temperature over the wall of the discharge vessel. This is furthermore promoted by the fact that in a body thus shaped the volume section between electrode and respective projecting plug, which section is non-cylindrical and curved towards the long axis, is relative small in comparison with the corresponding volume fraction of a cylindrical discharge vessel.

In FIG. 4, the spectrum of a lamp, whose metal halide filling substantially comprises an excess amount of 10 mg LiI, is shown with curve 1. For comparison, the spectrum is shown alongside a curve 2 of a lamp, whose filling comprises NaI instead of LiI. In both lamps the filling of the discharge vessel also comprises Hg as a buffer gas and 300 mbar Ar/Kr. The lamp according to the invention has a coldest-spot temperature T_{cs} of 1376 K during normal operation. The coldest-spot temperature T_{cs} was measured directly by means of an infrared camera. The spectrum of the non-invented lamp is equivalent to the spectrum of an ordinary HPS lamp. It is clear from the shown spectra that the blue fraction in the spectrum 1 of the LiI-comprising lamp is much higher than that of the HPS equivalent spectrum 2. It is also clearly shown that the spectrum 1 emits much more radiation in the region from 600 to 700 nm than the spectrum 2. A further advantage of the lamp according to the invention is that its visible lumens are more than a factor 2 lower than those of a HPS lamp or of an NaI-comprising lamp of comparable power. As a result of this, the lighting for plant growing, so-called assimilation lighting, results in less illumination of the surroundings.

An advantage of the inflated design according to the invention with curvatures towards the long axis at both ends is that the surface to volume ratio, A/V, is reduced. The consequence of this particular effect is elucidated with the aid of FIG. 5. The ratio of the power between 400 and 700 nm (denoted P₄₀₀₋₇₀₀ₙₘ) to the lamp input power (denoted Pₙₒₘ), further called power efficiency, is shown as a function of the surface to volume ratio, A/V, for a variety of lamps according to the invention referenced S1. For comparison, the results of cylindrical lamps are shown and referenced C1. Lamps S1 according to the invention generally have a power efficiency higher than those according to a design indicated with C1. Another advantage of design S1 is elucidated with reference to FIG. 6, in which the power efficiency, P₄₀₀₋₇₀₀ₙₘ/Pₙₒₘ, of the lamps is shown as a function of the electrode distance EA, i.e. the distance between the electrode tips. When the electrode distance increases, the power efficiency steadily increases and is greater for lamps S1 of the invention than for lamps with a discharge vessel design C1.

Results of experimental lamps are described below in Examples I and II.

### EXAMPLE I

The outline of the discharge vessels corresponds to FIG. 2. The dimensions are summarized in Table 1. The enclosed volume V and inner wall area A of the designs E2-1 were 3215 mm³ and 1087 mm², those of E2-2 2083 mm³ and 1051 mm². The resulting values for the ratio A/V then is 0.338 in design E2-1 and 0.504 in design E2-2. The buffer gas pressure was Xe with 100 mbar at room temperature. The lamp fillings and the results of the measured photon flux between 400-700 nm (dn/dt)₄₀₀₋₇₀₀ₙₘ divided by the lamp input power (photon flux efficiency) and the average wavelength <lambda>₄₀₀₋₇₀₀ₙₘ of the lamp emission between 400 and 700 nm are listed in Table 2. It was furthermore established that the coldest-spot temperature T_{cs} in each lamp was more than 1200K.

TABLE 1

| | d1 | d2 | 3 | A-1 | B-1 | C | 7 | 8 | 9 |
|---|---|---|---|---|---|---|---|---|---|
| | (mm) | (mm) | (mm) | (mm) | (mm) | (mm) | (mm) | (mm) | (mm) |
| E2-1 | 4 | 1.64 | 17 | 8.5 | 1.5 | 24.6 | 17 | 1 | 58.6 |
| E2-2 | 4 | 1.64 | 17 | 5.1 | 1.5 | 42 | 10.2 | 1 | 76 |

TABLE 2

| | | | | (dn/dt)_{400-700 nm}/ | |
|---|---|---|---|---|---|
| Discharge | Pᵢₙₚᵤₜ | m_{LiI} | m_{Hg} | Pᵢₙₚᵤₜ | <lambda>_{400-700 nm} |
| vessel | [W] | [mg] | [mg] | [micromole/J] | [nm] |
| E2-1 | 320 | 28 | 36 | 1.63 | 597 |
| E2-1 | 390 | 28 | 36 | 1.59 | 593 |
| E2-2 | 320 | 30 | 8 | 1.75 | 598 |
| E2-2 | 390 | 30 | 8 | 1.80 | 595 |
| E2-2 | 310 | 30 | 10 | 1.82 | 601 |
| E2-2 | 390 | 30 | 10 | 1.89 | 597 |
| E2-2 | 315 | 30 | 12 | 1.79 | 601 |
| E2-2 | 425 | 30 | 12 | 1.90 | 595 |

The results in Table 2 show that the photon flux efficiency and the average wavelength increase when the burner length increases. Increasing the power in a burner also decreases the average wavelength but surprisingly increases the photon flux efficiency.

For comparison, in a lamp in which the halide is NaI, the photon flux per unit power is only 1.35 μmole/(W*s). A HPS lamp with a nominal power of 150 W has a photon flux per unit power of 1.29 μmol/(W*s).

### EXAMPLE II

Lamps are made with ellipsoidal discharge vessel designs as shown in FIG. 3. The discharge vessel body length C, outer diameter 7, wall thickness 8, inner wall surface A and volume V are listed in Table 3. The radius B-1 at the transition between body and elongated feedthrough in FIG. 3 is 2 mm. The lamp fillings and the results of the measured photon flux between 400-700 nm (dn/dt)₄₀₀₋₇₀₀ₙₘ divided by the lamp input power (photon flux efficiency) and the average wavelength <lambda>₄₀₀₋₇₀₀ₙₘ of the lamp emission between 400 and 700 nm are given in Table 4.

TABLE 3

| | C | 7 | A-1 | 8 | A | V | A/V |
|---|---|---|---|---|---|---|---|
| | [mm] | [mm] | [mm] | [mm] | [mm²] | [mm³] | [mm⁻¹] |
| E3-1 | 38 | 19.7 | 27.6 | 1.4 | 1511 | 4772 | 0.317 |
| E3-2 | 69 | 12 | 160.6 | 1.4 | 1459 | 2270 | 0.641 |

TABLE 4

| Dis- | | m_{LiI} & | | (dn/dt)_{400-700 nm}/ | |
|---|---|---|---|---|---|
| charge | Pᵢₙₚᵤₜ | m_{CeI3} | m_{Hg} | Pᵢₙₚᵤₜ | <lambda>_{400-700 nm} |
| vessel | [W] | [mg] | [mg] | [micromole/J] | [nm] |
| E3-1 | 390 | 30 &0 | 50 | 1.76 | 606 |
| E3-2 | 390 | 30 &0 | 7 | 1.89 | 603 |
| E3-2 | 585 | 30 &0 | 7 | 1.99 | 598 |
| E3-2 | 430 | 50 &7 | 7.2 | 1.93 | 578 |
| E3-2 | 480 | 50 &7 | 7.2 | 1.97 | 575 |

In the lamps which have a halide filling comprising besides LiI also CeI₃, the amount of CeI₃ corresponds to 3.5 mole %. It was furthermore established that the coldest-spot temperature T_{cs} in each lamp was more than 1200K.

Editor's note: the quantity “photon flux efficiency” is introduced in this text as a replacement for “luminous efficacy”. Is it perhaps better to speak of “photon flux efficacy”? Efficacy denotes a conversion of energy (e.g. from watts to lumens), whereas efficiency stays within the same kind of energy (e.g. in a luminaire the efficiency may be 90%: 1000 lm from the lamp, of which 900 lm actually issue from the window of the luminaire). So efficiency is just a number, efficacy always has a unit denoted behind it.
Please delete this note after consideration.

1. A high-pressure discharge lamp having a discharge vessel with a long axis enclosing a volume V, wherein an ionizable filling comprising a buffer gas and an excess amount of substantially LiI as a metal halide is present, the discharge vessel having an inflated shape that curves towards the long axis at both ends, with an inner wall area A for which it holds that A/V<0.66 mm⁻¹, which discharge vessel has a coldest-spot temperature T_{cs} of at least 1200 K during normal operation.

2. A lamp according to claim 1, wherein the ionizable filling also comprises CeI₃.

3. A lamp according to claim 2, wherein the CeI₃ is present in a quantity of at most about 10 mole %.

4. A lamp according to claim 1, wherein the discharge vessel encloses a pair of electrodes at a mutual electrode distance EA that is at least about 20 mm.

5. A lamp according to claim 1, wherein the discharge vessel is made of ceramic material.

6. A lamp according to claim 1, wherein the buffer gas comprises Hg.

7. A lamp according to claim 6?, wherein the buffer gas also comprises Xe.
